(19) United States
(12) Patent Application Publication
(10) Pub. No.: US 2014/0158870 A1
(43) Pub. Date: Jun. 12, 2014

(54) VARIABLE-WAVELENGTH LIDAR SYSTEM

(71) Applicant: LaSen, Inc., Las Cruces, NM (US)

(72) Inventors: Michael DeAntonio, Las Cruces, NM (US); Ralph Motto, Las Cruces, NM (US)

(73) Assignee: LaSen, Inc., Las Cruces, NM (US)

(21) Appl. No.: 14/101,143

(22) Filed: Dec. 9, 2013

Related U.S. Application Data
(60) Provisional application No. 61/734,635, filed on Dec. 7, 2012.

(51) Int. Cl. G01S 17/02

(52) U.S. Cl. CPC G01S 17/026
USPC 250/216

(57) ABSTRACT

A narrow-linewidth, variable-wavelength, active, absorbing LIDAR (Light Detection and Ranging) system and method. The linewidth of the source and detector is sufficiently narrow to produce a reasonable signal-to-noise ratio for the system. The central wavelength of the source and detector can be synchronously changed. The system comprises a tunable light-emitting source and uses the absorption of light to determine the chemical composition of the item being detected. A wavelength tunable filter synchronized to the tunable source reduces or eliminates background noise and thus increases the level of detection for low concentrations of the substance to be detected.

### CROSS-REFERENCE TO RELATED APPLICATIONS

This Application claims priority to and the benefit of the filing of U.S. Provisional Patent Application Ser. No. 61/734,635, filed Dec. 7, 2012, entitled “Variable-Wavelength LIDAR System”, the specifications and claims of which are incorporated herein by reference.

### BACKGROUND OF THE INVENTION

### Field of the Invention (Technical Field)

The present invention is a narrow-linewidth, variable-wavelength, active, absorbing LIDAR (Light Detection and Ranging) system preferably used for remote detection or characterization of solids, fluids, gases, and/or plasmas. The linewidth of the source and detector is preferably sufficiently narrow to produce a reasonable signal-to-noise ratio for the system.

### SUMMARY OF THE INVENTION (DISCLOSURE OF THE INVENTION)

The present invention is a variable wavelength absorbing light detection and ranging (LIDAR) system for detecting the presence of a substance. The system preferably comprises a tunable light source and tunable receiver. The tunable light source and/or the tunable receiver are preferably narrow-linewidth, wherein the linewidth of the tunable light source and/or the tunable receiver is preferably between approximately 1 nm and approximately 10 nm. The tunable light source preferably comprises a device selected from the group consisting of a laser, a fiber laser, a quantum cascade laser (QCL), a vertical cavity laser (VCL), or an optical parametric oscillator (OPO). The tunable receiver preferably comprises a tunable filter, preferably an acousto-optical tunable filter. A wavelength of the tunable filter is preferably synchronized to a wavelength of the tunable light source. The system preferably further comprises a field of view (FOV) lens, which preferably compensates for the narrow acceptance angle of the tunable filter and preferably comprises CaF₂. The system is preferably capable of detecting multiple substances using the same hardware components.

The present invention is also method for detecting the presence of a substance, the method comprising illuminating an area that might contain the substance with a source of light, the light having a center wavelength that is absorbed by the substance; receiving light from the area; synchronizing a center wavelength of a tunable filter with the center wavelength of the source of light; selecting a narrow band of wavelengths around the center wavelength of the received light using the tunable filter; measuring a magnitude of light at one or more wavelengths within the narrow band of wavelengths; measuring a magnitude of light at one or more wavelengths outside the narrow band of wavelengths; and comparing the magnitudes. The method optionally further comprises repeating the illuminating, receiving, selecting, measuring, and comparing steps with a second wavelength of light that is absorbed by a second substance. The method preferably further comprises passing the received light through a field of view (FOV) lens prior to the selecting step.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate embodiments of the present invention and, together with the description, serve to explain the principles of the invention. The drawings are only for the purpose of illustrating embodiments of the invention and are not to be construed as limiting the invention. In the drawings:

FIG. 1 is a basic schematic of a LIDAR system.

FIG. 2 shows an embodiment of a variable-wavelength LIDAR.

FIGS. 3A-3D schematically depict the outputs of the detectors in the embodiment of FIG. 2.

FIG. 4 is another embodiment of a variable-wavelength LIDAR.

FIGS. 5A-5B schematically depict the output of the detector in the embodiment of FIG. 4.

FIG. 6 is a schematic of a field of view (FOV) lens for use with a tunable filter in accordance with embodiments of the present invention.

FIG. 7 is a schematic of a LIDAR receiver with a tunable filter and no FOV lens.

FIG. 8 is a schematic of a LIDAR receiver with a tunable filter and an FOV lens.

### DETAILED DESCRIPTION OF EMBODIMENTS OF THE INVENTION

The present invention is a LIDAR system that preferably comprises components which together serve to reduce background noise and increase the level of detection. Embodiments of the present invention comprise an active LIDAR system, i.e. comprising a light source within and not external to the system, and/or an absorbing LIDAR system, i.e. using absorption of light from the substance to be measured in order to detect or characterize the substance.

As used throughout the specification and claims, the term “light” means any electromagnetic radiation.

As used throughout the specification and claims, the term “narrow-linewidth” means a linewidth sufficiently narrow to remotely distinguish or characterize a desired substance. Either or both of the light source and detector may be narrow-linewidth.

As used throughout the specification and claims, the term “substance” means any solid, fluid, liquid, gas, plasma, material, and the like.

As used throughout the specification and claims, the term “variable wavelength” means the system has the ability to synchronously vary the center wavelength of both the source and detector.

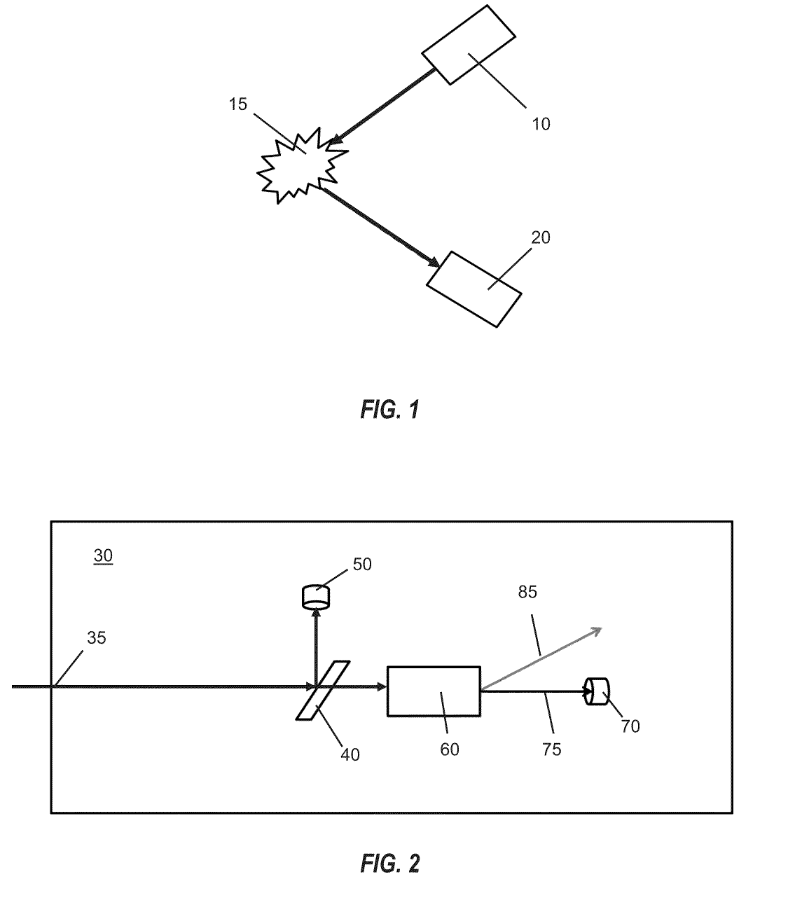

FIG. 1 is a schematic of an embodiment of a LIDAR system in accordance with the present invention. Tunable light source 10 may comprise any light source, including but not limited to a laser/Optical Parametric Oscillator (OPO), a fiber laser, a quantum cascade laser (QCL), or a vertical cavity laser (VCL). Tunable receiver 20 may consist of one or more detectors and corresponding optical systems, including but not limited to any detector made from InSb or HgCdTe, whether uncooled or cooled by any cooling method such as using liquid nitrogen, thermoelectrically, or using a sterling engine. The receiver preferably comprises a dynamic tunable filter of any type, such as an Acousto-Optic Tunable Filter (AOTF), for lowering or eliminating background noise well beyond the level of current DIAL (differential absorption LIDAR) systems.

The system preferably shines light of two specific wavelengths from the tunable source. The first wavelength (online) is preferably readily absorbed by target substance 15. The second wavelength (offline) is preferably easily transmitted through the substance. It is the difference in the transmission of these two wavelengths that is used to determine the presence of the substance in the beam. Two wavelengths in the mid-IR range are preferably used by a laser beam preferably having a linewidth of 1 nm. The beam is typically reflected or backscattered off of a background (typically the ground surface). A return signal from both wavelengths is expected when the target substance is not present. A return signal from the offline beam but not the online beam is expected when the target substance is present, since the online beam is absorbed by the substance.

However, light from other sources with different wavelengths also returns along with the original laser beams, producing background noise. Typical DIAL LIDARs, which may use a tunable laser system, filter out this noise with a static large bandwidth bandpass filter that allows both the online and offline wavelengths to pass. However, this configuration passes background wavelengths, such as those that are between the online and offline beam wavelengths, through to the detector, which are seen by the system as background noise, limiting the level of detection. If a separate static notch filter for each of the laser beam wavelengths is used to reduce such background wavelengths, the system is limited to detecting or characterizing substances that have similar absorption characteristics.

The addition of a tunable filter enables the center frequency of the filter to vary dynamically, thereby creating a dynamic notch filter. The entire system preferably becomes dynamic, enabling the detection of multiple target materials with completely different absorption characteristics using a single system. The dynamic notch filter preferably comprises a narrow linewidth (typically on the order of 1-10 nm). This limits or prevents light from wavelengths other than those of the online or offline beams from reaching the detector, thus significantly reducing the background noise.

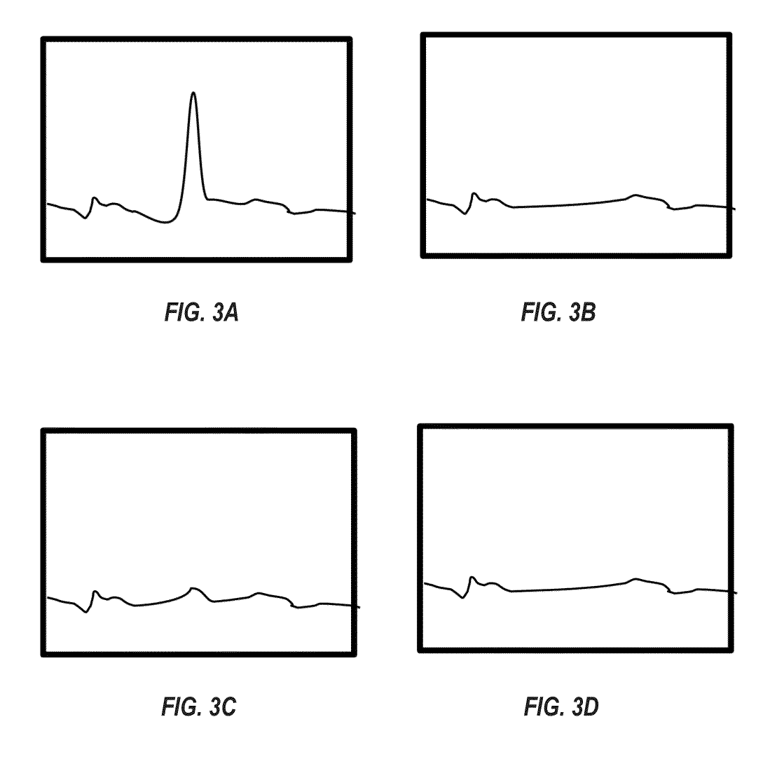

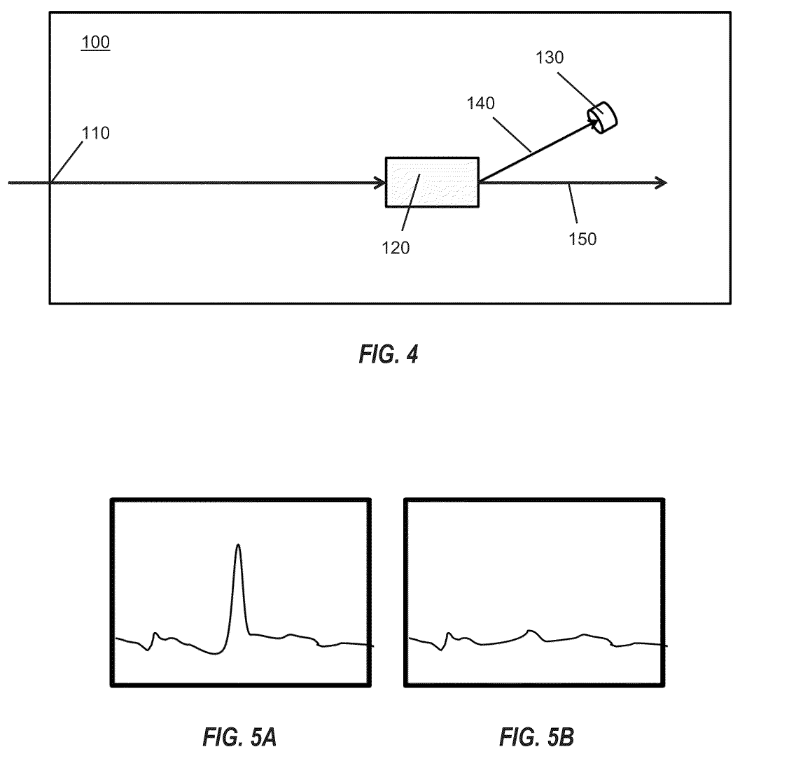

The tunable filter is preferably synchronized to the tunable laser or other light source, thus forming a variable-wavelength LIDAR system. An example system comprises a tunable OPO source paired with an AOTF that operates in the same wavelength region. This system can switch a single laser system between multiple online and offline wavelengths, where each online wavelength is chosen for a particular substance to be detected, resulting in a dynamic system able to detect several substances while, for example, passing above them in an aircraft. Embodiments of such a system are illustrated in FIGS. 2 and 4, which comprise a tunable light source and a tunable receiver. In FIG. 2, tunable receiver 30 preferably comprises input 35, beamsplitter 40, first detector 50, tunable filter 60, and second detector 70. First output 75 comprises all wavelengths except for a narrow band around the online frequency of acousto-optic tunable filter 60 (i.e. the absorption wavelength of the target substance) and is directed to second detector 70, which preferably comprises a mid-infrared HgCdTe detector that is TEC cooled. Second output 85, which comprises only the narrow band around the online frequency, may be ignored, or alternatively may be directed to another detector (not shown), which may be substituted for first detector 50. The output signals of the two detectors of this embodiment in response to online illumination are schematically depicted in FIG. 3; FIG. 3A shows the output of first detector 50 with no target substance present, FIG. 3B shows the output of first detector 50 with the target substance present. FIGS. 3C and 3D show the output of second detector 70 without and with the presence of the target substance, respectively. Because tunable filter 60 selects out the online frequency, these signals essentially measure the noise in the measurement. In order to quantify the amount of the target present, the outputs of second detector 70 will be either subtracted from or divided into the output of first detector 50.

FIG. 4 shows another embodiment of a variable-wavelength LIDAR of the present invention, in which tunable receiver 100 comprises input 110, tunable filter 120, and detector 130 which is placed to receive output 140 of tunable filter 120. Output 140 comprises only a narrow band around the online frequency. Output 150 of tunable filter 120 comprises all wavelengths except for those in the narrow band around the online frequency, is ignored in this embodiment. The output signals of the detector 130 of this embodiment in response to online illumination are schematically depicted in FIG. 5; FIG. 5A shows the output of detector 130 with no target substance present. FIG. 5B shows the output of detector 130 with the target substance present. (The substance has absorbed some or all of the online radiation, thereby removing the peak in the signal.) The latter output can be subtracted from or divided into the former in order to quantify the amount of the target substance present.

### Field of View (FOV) Lens

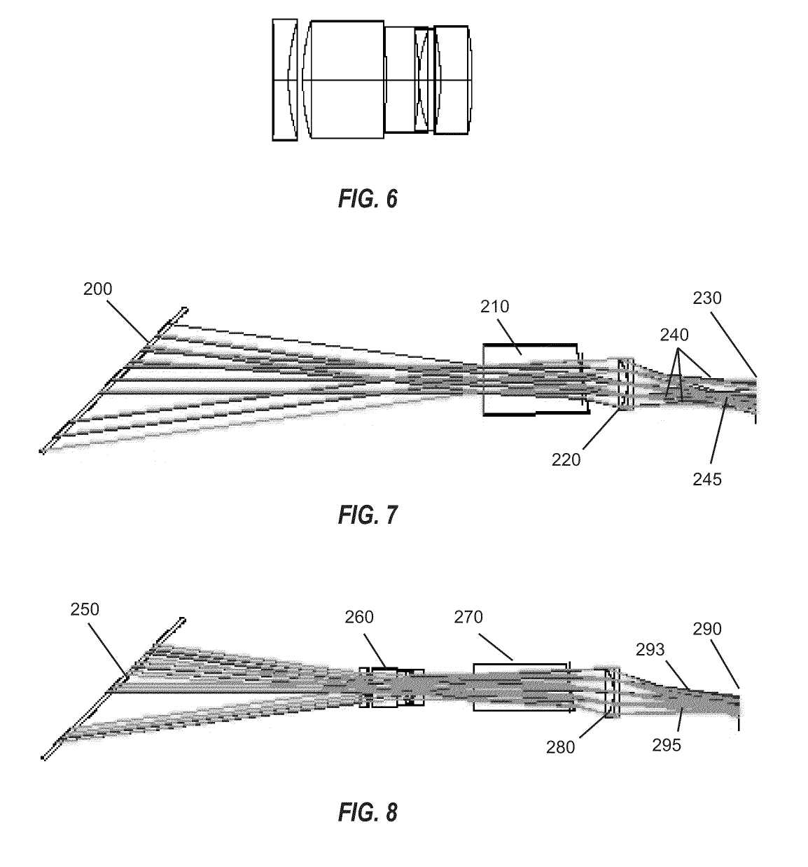

Because of the narrow acceptance angle of typical tunable filters, it is difficult if not impossible for the filter to separate the 1^{st} order signal beam (the narrow band surrounding the online wavelength) from the 0^{th} order dump beam (all other wavelengths). Therefore it is useful to utilize a field-of-view (FOV) lens, such as one shown in FIG. 6, that will enable the filter to spatially separate the 0^{th} and 1^{st} order beams. Such an FOV lens preferably comprises CaF₂ and is typically difficult to construct. FIG. 7 shows a receiver system without an FOV lens. Input light reflects from receiver system input mirror 200, through tunable filter 210 and receiver lens 220 before reaching detector face 230. The 0^{th} order beam is shown by the black lines 240, and the 1^{st} order beam is shown as shaded area 245. As shown in FIG. 7, the two beams spatially mix together and are not separable. FIG. 8 shows the same system with an FOV lens. Input light reflects from receiver system input mirror 250, through FOV lens 260, tunable filter 270 and receiver lens 280 before reaching detector face 290. The 0^{th} order beam is shown by the black lines 293, and the 1^{st} order beam is shown as shaded area 295. As shown in FIG. 8, the two beams are spatially separated, enabling the detector in certain embodiments (such as that shown in FIG. 4) to receive only the 1^{st} order signal beam.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A variable wavelength absorbing light detection and ranging (LIDAR) system for detecting the presence of a substance.

2. The system of claim 1 comprising a tunable light source and tunable receiver.

3. The system of claim 2 wherein the tunable light source and/or the tunable receiver are narrow-linewidth.

4. The system of claim 3 wherein the linewidth of the tunable light source and/or the tunable receiver is between approximately 1 nm and approximately 10 nm.

5. The system of claim 2 wherein the tunable light source comprises a device selected from the group consisting of a laser, a fiber laser, a quantum cascade laser (QCL), a vertical cavity laser (VCL), or an optical parametric oscillator (OPO).

6. The system of claim 2 wherein the tunable receiver comprises a tunable filter.

7. The system of claim 6 wherein the tunable filter comprises an acousto-optical tunable filter.

8. The system of claim 6 wherein a wavelength of the tunable filter is synchronized to a wavelength of the tunable light source.

9. The system of claim 6 further comprising a field of view (FOV) lens.

10. The system of claim 9 wherein the FOV lens compensates for a narrow acceptance angle of the tunable filter.

11. The system of claim 9 wherein the FOV lens comprises CaF₂.

12. The system of claim 1 capable of detecting multiple substances.

13. A method for detecting the presence of a substance, the method comprising:
illuminating an area that might contain the substance with a source of light, the light having a center wavelength that is absorbed by the substance;
receiving light from the area;
synchronizing a center wavelength of a tunable filter with the center wavelength of the source of light;
selecting a narrow band of wavelengths around the center wavelength of the received light using the tunable filter;
measuring a magnitude of light at one or more wavelengths within the narrow band of wavelengths;
measuring a magnitude of light at one or more wavelengths outside the narrow band of wavelengths; and
comparing the magnitudes.

14. The method of claim 13 further comprising repeating the illuminating, receiving, selecting, measuring, and comparing steps with a second wavelength of light that is absorbed by a second substance.

15. The method of claim 13 further comprising passing the received light through a field of view (FOV) lens prior to the selecting step.
